(19) United States
(12) Patent Application Publication
(10) Pub. No.: US 2015/0153014 A1
(43) Pub. Date: Jun. 4, 2015

(54) LUMINESCENT ELONGATED LIGHT ASSEMBLY

(71) Applicant: Ford Global Technologies, LLC, Dearborn, MI (US)

(72) Inventors: Stuart C. Salter, White Lake, MI (US); Paul Kenneth Dellock, Northville, MI (US); James J. Surman, Clinton Township, MI (US); John Matthew Teodecki, Grosse Point Park, MI (US)

(73) Assignee: Ford Global Technologies, LLC

(21) Appl. No.: 14/617,102

(22) Filed: Feb. 9, 2015

Related U.S. Application Data
(63) Continuation-in-part of application No. 14/086,442, filed on Nov. 21, 2013.

(51) Int. Cl. F21S 8/10; G02B 1/00; B29C 45/14; C25D 7/00; F21V 29/70; F21K 99/00

(52) U.S. Cl. CPC F21S 48/1241; F21V 29/70; F21K 9/56; B29C 45/14778; C25D 7/00; G02B 1/00; F21Y 2103/003

(57) ABSTRACT

An elongated light assembly is disclosed. The elongated light assembly comprises a luminescent portion disposed on a housing. The elongated light assembly further includes a light source located proximate the housing. The light source is configured to emit light at a first wavelength directed toward the luminescent portion. The luminescent portion is configured to convert the first wavelength to at least a second wavelength to illuminate a portion of the elongated light assembly housing.

### CROSS-REFERENCE TO RELATED APPLICATION

This application is a continuation-in-part of U.S. patent application Ser. No. 14/086,442, filed Nov. 21, 2013, and entitled “VEHICLE LIGHTING SYSTEM WITH PHOTOLUMINESCENT STRUCTURE,” the entire disclosure of which is hereby incorporated herein by reference.

### FIELD OF THE INVENTION

The present invention generally relates to vehicle lighting systems, and more particularly, to vehicle lighting systems employing photoluminescent structures.

### BACKGROUND OF THE INVENTION

Illumination arising from photoluminescent materials offers a unique and attractive viewing experience. It is therefore desired to incorporate such photoluminescent materials in portions of vehicles to provide quality lighting assemblies.

### SUMMARY OF THE INVENTION

According to one aspect of the present invention, an elongated light assembly for a vehicle is disclosed. The elongated light assembly comprises a substrate mated to a housing. The elongated light assembly a light source disposed between the substrate and housing. A portion of the housing is configured to luminesce in response to excitation by light emitted from the light source.

According to another aspect of the present invention, an elongated light assembly for a vehicle is disclosed. The elongated light assembly comprises an elongated substrate with an elongated light guide disposed within the substrate. The system further includes a light source disposed at a first end of the substrate, wherein the light source emits light at a first wavelength. A housing is coupled to the substrate. A photoluminescent material is disposed on the housing. The photoluminescent material is configured to convert the light at a first wavelength to a second wavelength.

According to yet another aspect of the present disclosure, a method for creating an elongated light assembly is disclosed. The method includes the step of an injection molding a substrate. Next, a light guide is injection molded and coupled to the substrate 38 within a mold. A printed control board and light source are placed into the mold. The printed control board and light source are then coupled to the substrate via a molding step.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a photoluminescent structure rendered as a coating for use in an elongated light assembly according to one embodiment;

FIG. 1B is a top view of a photoluminescent structure rendered as a discrete particle according to one embodiment;

FIG. 1C is a side view of a plurality photoluminescent structures rendered as discrete particles and incorporated into a separate structure;

FIG. 2 is a front perspective view of a vehicle comprising a headlight assembly having a luminescent elongated light assembly disposed therein;

FIG. 3 illustrates a cross-sectional view of a vehicle having a luminescent headlight assembly taken along the lines of III-III of FIG. 2;

FIG. 4 is a perspective view of an elongated light assembly substrate having a heat sink attached thereto;

FIG. 5 is a perspective view of the elongated light assembly substrate of FIG. 5 having the luminescent elongated light assembly molded therein; and

FIG. 6 is a block diagram of the vehicle lighting system.

### DETAILED DESCRIPTION OF THE PREFERRED EMBODIMENTS

As required, detailed embodiments of the present disclosure are disclosed herein. However, it is to be understood that the disclosed embodiments are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a lighting system for a headlight assembly having a luminescent elongated light assembly therein that advantageously employs one or more photoluminescent structures configured to convert light received from an associated light source and re-emit the light at a different wavelength.

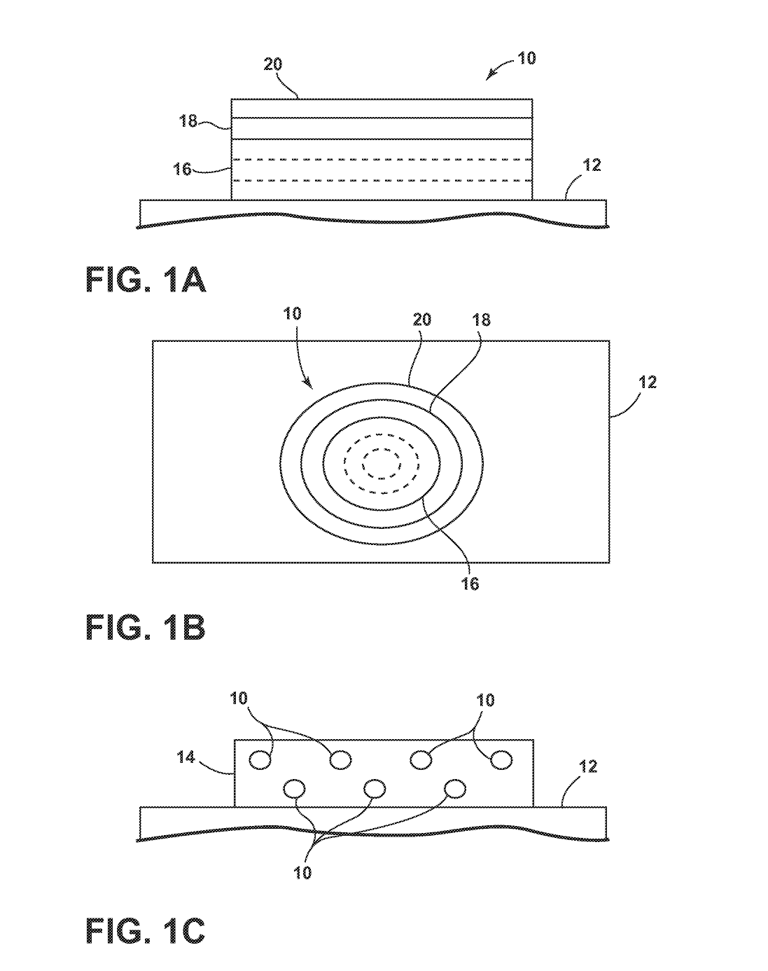

Referring to FIGS. 1A-1C, various exemplary embodiments of a photoluminescent structures 10 are shown, each capable of being coupled to support member, such as an elongated light system component 12. In FIG. 1A, the photoluminescent structure 10 is generally shown rendered as a coating 14 (e.g., a film) that may be applied to a surface of the support member 12. In FIG. 1B, the photoluminescent structure 10 is generally shown as a discrete particle capable of being integrated with a support member 12. In FIG. 1C, the photoluminescent structure 10 is generally shown as a plurality of discrete particles that may be incorporated into a support medium 14 (e.g., a film) that may then be applied (as shown) or integrated with the support member 12.

At the most basic level, a given photoluminescent structure 10 includes an energy conversion layer 16 that may include one or more sub layers, which are exemplarily shown through broken lines in FIGS. 1A and 1B. Each sub layer of the energy conversion layer 16 may include one or more photoluminescent materials having energy converting elements with phosphorescent or fluorescent properties. Each photoluminescent material may become excited upon receiving light of a specific wavelength, thereby causing the light to undergo a conversion process resulting in luminescence of the photoluminescent material. Under the principle of down conversion, the inputted light is converted into a longer wavelength light that is outputted from the photoluminescent structure 10. Conversely, under the principle of up conversion, the inputted light is converted into a shorter wavelength light that is outputted from the photoluminescent structure 10. When multiple distinct wavelengths of light are outputted from the photoluminescent structure 10 at the same time, the wavelengths of light may mix together and be expressed as a multicolor light.

In some embodiments, light that has been down converted or up converted may be used to excite other photoluminescent material(s) found in the energy conversion layer 16. The process of using converted light outputted from one photoluminescent material to excite another, and so on, is generally known as an energy cascade and may serve as an alternative for achieving various color expressions. With respect to either conversion principle, the difference in wavelength between the exciting light and the converted light is known as the Stokes shift and serves as the principle driving mechanism for an energy conversion process corresponding to a change in wavelength of light. In the various embodiments discussed herein, each of the photoluminescent structures 10 may operate under either conversion principle.

The energy conversion layer 16 may be prepared by dispersing the photoluminescent material in a polymer matrix to form a homogenous mixture using a variety of methods. Such methods may include preparing the energy conversion layer 16 from a formulation in a liquid carrier medium and coating the energy conversion layer 16 to a desired support member 12. The energy conversion layer 16 may be applied to a support member 12 by painting, screen printing, spraying, slot coating, dip coating, roller coating, and bar coating. Alternatively, the energy conversion layer 16 may be prepared by methods that do not use a liquid carrier medium. For example, the energy conversion layer 16 may be rendered by dispersing the photoluminescent material into a solid state solution (homogenous mixture in a dry state) that may be incorporated in a polymer matrix, which may be formed by extrusion, injection molding, compression molding, calendaring, thermoforming, etc. The energy conversion layer 16 may then be integrated into a support member 12 using any methods known to those skilled in the art. When the energy conversion layer 16 includes sub layers, each sub layer may be sequentially coated to form the energy conversion layer 16. Alternatively, the sub layers can be separately prepared and later laminated or embossed together to form the energy conversion layer 16. Alternatively, the energy conversion layer 16 may be formed by coextruding the sub layers.

Referring back to FIGS. 1A and 1B, the photoluminescent structure 10 may optionally include at least one stability layer 18 to protect the photoluminescent material contained within the energy conversion layer 16 from photolytic and thermal degradation. The stability layer 18 may be configured as a separate layer optically coupled and adhered to the energy conversion layer 16. Alternatively, the stability layer 18 may be integrated with the energy conversion layer 16. The photoluminescent structure 10 may also optionally include a protection layer 20 optically coupled and adhered to the stability layer 18 or other layer (e.g., the conversion layer 16 in the absence of the stability layer 18) to protect the photoluminescent structure 10 from physical and chemical damage arising from environmental exposure. The stability layer 18 and/or the protective layer 20 may be combined with the energy conversion layer 16 through sequential coating or printing of each layer, sequential lamination or embossing, or any other suitable means.

Additional information regarding the construction of photoluminescent structures 10 is disclosed in U.S. Pat. No. 8,232,533 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” filed Jul. 31, 2012, the entire disclosure of which is incorporated herein by reference. For additional information regarding fabrication and utilization of photoluminescent materials to achieve various light emissions, refer to U.S. Pat. No. 8,207,511 to Bortz et al., entitled “PHOTOLUMINESCENT FIBERS, COMPOSITIONS AND FABRICS MADE THEREFROM,” filed Jun. 26, 2012; U.S. Pat. No. 8,247,761 to Agrawal et al., entitled “PHOTOLUMINESCENT MARKINGS WITH FUNCTIONAL OVERLAYERS,” filed Aug. 21, 2012; U.S. Pat. No. 8,519,359 B2 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” filed Aug. 27, 2013; U.S. Pat. No. 8,664,624 B2 to Kingsley et al., entitled “ILLUMINATION DELIVERY SYSTEM FOR GENERATING SUSTAINED SECONDARY EMISSION,” filed Mar. 4, 2014; U.S. Patent Publication No. 2012/0181477 to Agrawal et al., entitled “PHOTOLUMINESCENT COMPOSITIONS, METHODS OF MANUFACTURE AND NOVEL USES,” filed Jul. 19, 2012; U.S. Patent Publication No. 2014/0065420 A1 to Kingsley et al., entitled “PHOTOLUMINESCENT OBJECTS,” filed Mar. 6, 2014; and U.S. Patent Publication No. 2014/0103258 A1 to Agrawal et al., entitled “CHROMIC LUMINESCENT COMPOSITIONS AND TEXTILES,” filed Apr. 17, 2014, all of which are incorporated herein by reference in their entirety.

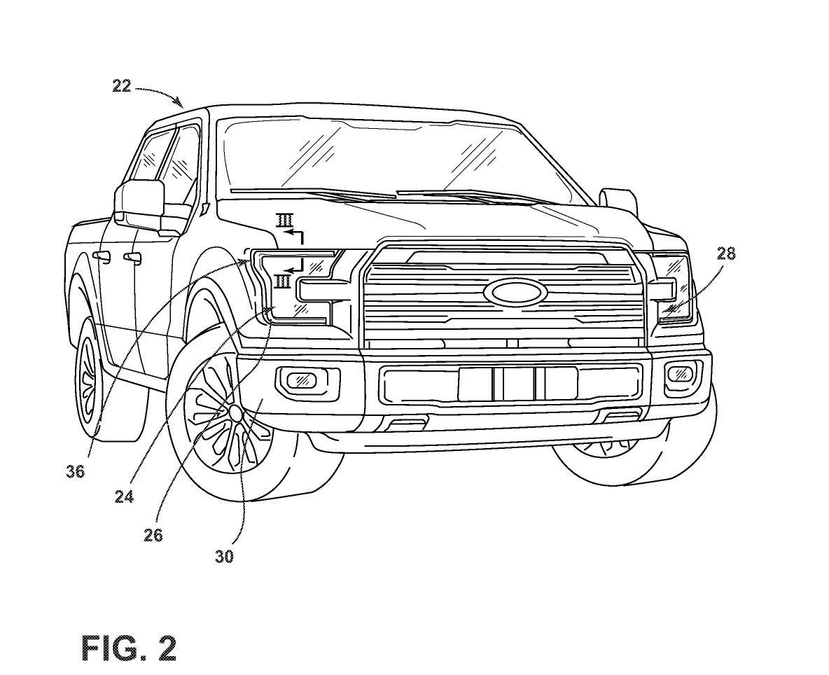

Referring to FIG. 2, a vehicle 22 is shown having a headlight assembly 24 including a luminescent elongated light assembly 26 located in a front fascia 28 of the vehicle 22. The headlight assembly is generally disposed proximate the front bumper 30 of the vehicle 22. The headlight assembly may also function as a styling element that is used to enhance the appearance of the vehicle 22. The headlight assembly may include a plurality of light sources within the vehicle 22 assembly and each light source 32 may have a different use. An elongated light assembly 26 having a length of which is greater than its diameter is also disposed within the headlight assembly 24 to provide additional lighting for the vehicle 22. The elongated light assembly 26 includes a light source 32 and a luminescent portion 34. The luminescent portion 34 includes at least one photoluminescent structure 10.

The elongated light assembly 26 may be disposed anywhere within the headlight assembly 24 and may perform any necessary function. As will be described below in greater detail, each of the headlight assemblies 24 or elongated light assemblies 26 may be configured to provide one or more distinct lighting functions. For instance, each elongated light assembly 26 may have a front portion 36 that illuminates in a first and second color. When the vehicle is in a first state, the elongated light assembly provides outward glow in a first color. When the vehicle 22 is in a second state, the elongated light assembly 26 may appear as a second color. Through the use of photoluminescent structures 10, each color may appear uniform along the visible body of the elongated light assembly 26. The contrast in substantially uniform lighting between the different states imparts a distinct styling element to the headlight assembly. While a headlight assembly 24 for use in the front fascia 28 has been described herein, it should be understood that light assemblies in other vehicle locations may be similarly configured.

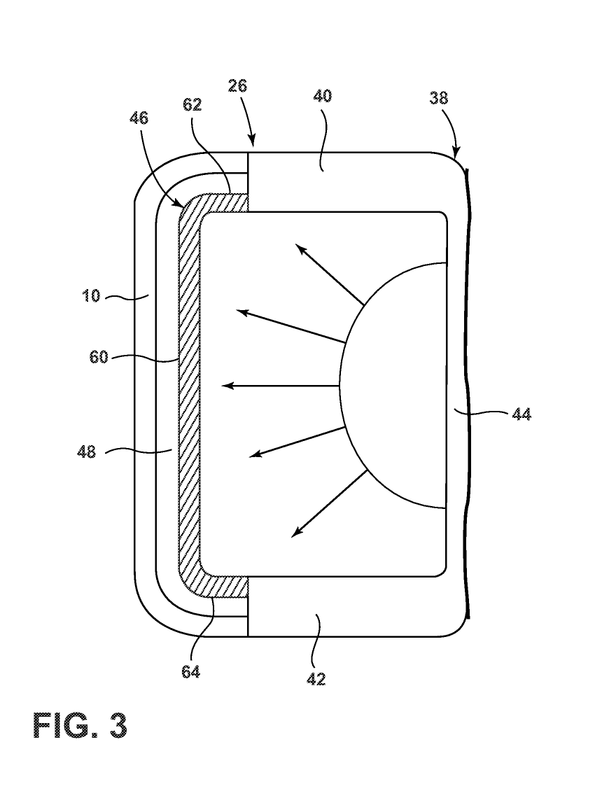

Referring to FIG. 3, cross section III-III of FIG. 2 illustrating an elongated light assembly 26 is shown according to one embodiment. The elongated light assembly 26 includes a substrate 38 having a top portion 40, a bottom portion 42, and a rear portion 44. Each portion 40, 42, 44 may be constructed from a rigid or pliable material that may be substantially light permeable, such as, but not limited to, plastic. The top portion 40, bottom portion 42, and rear portions 44 may be embodied in a one-piece tubular configuration that may be later assembled to a housing 46 via sonic or laser welding. Alternatively, the top and bottom rear portions of the substrate 38 may be assembled as a single piece through any known process, such as low-pressure insert molding. In the illustrated embodiment, the housing 46 is an outward component of the assembly that is substantially visible after the assembly has been mounted on a vehicle.

Portions of the substrate 38 and/or housing 46 that are readily visible may be colored any color or may be metalized to give the elongated light assembly 26 a metallic appearance. In one embodiment, a metallic layer 48 may be applied to any portion of the elongated light assembly 26 via electroplating a thin layer of chromium onto the housing 46. Alternatively, a less expensive imitator of chrome may be used for aesthetic purposes. The metallic layer 48 should be light permeable to allow light to pass therethrough from an inner side to an outer side. Alternate processes may be used for coloring or layering material onto a portion of the substrate 38 or housing 46, as known in the art.

The elongated light assembly 26 may also include a photoluminescent structure 10 coupled to the housing 46, and optionally, some or all of the top, bottom, and/or rear portions of the substrate 38. According to one embodiment, the photoluminescent structure 10 at least partially covers the metallic layer 48 and may be applied over the metallic layer 48 as a single continuous structure or multiple structures. The remaining uncovered portions of the metallic layer 48 may be covered by a light reflecting layer that includes, but is not limited to, white paint. In an alternative embodiment, the photoluminescent structure 10 may be molded or otherwise integrated into the housing 46 and/or the substrate 38.

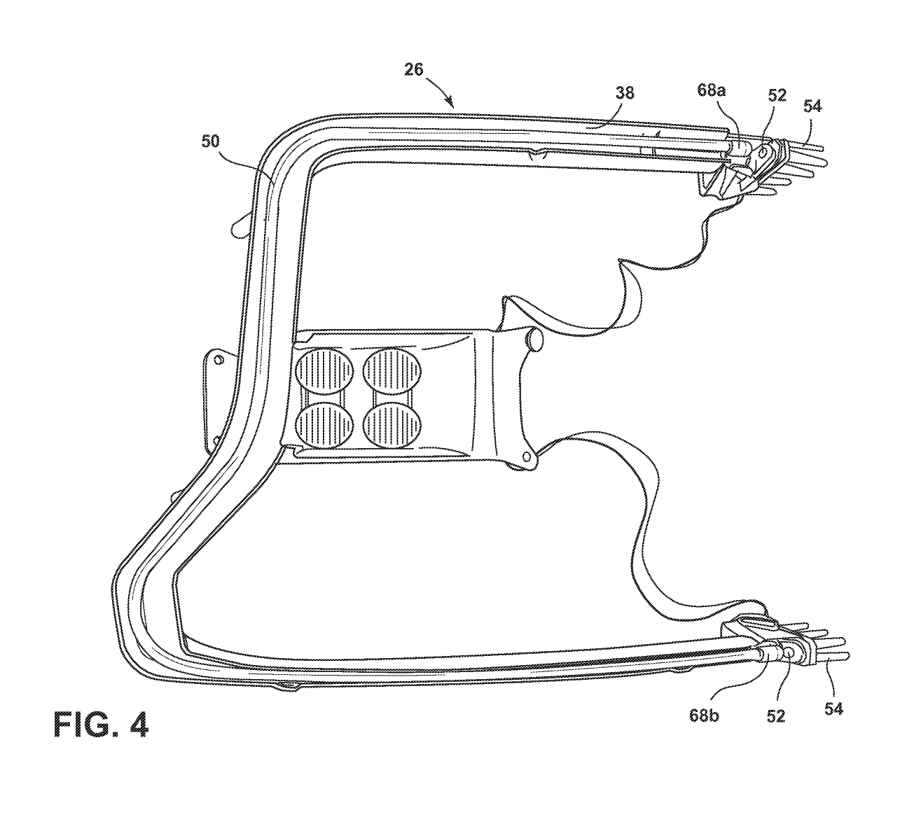

Referring to FIG. 4, an exemplary embodiment of the internal components of an elongated light assembly 26 is illustrated. The elongated light assembly 26 includes a substrate 38, a light guide 50, a light source 32, and a printed circuit board (PCB) 52 that is disposed proximate the substrate 38. The light guide 50, in the illustrated embodiment, is made of a clear acrylic material or another transparent thermoplastic. Although the light guide 50 is shown with a generally tubular shape, one of ordinary skill in the art would recognize that the light guide 50 could be rectangular, elliptical, or have a discontinuous perimeter. The light source 32 may be powered by a vehicle power supply 54 or other power supply 76. The PCB 52 may be secured to any portion of the substrate 38 and may be vertically aligned with the rear portion of the substrate 38. At least one light source 32 may be located in the elongated light assembly 26 proximate the PCB 52. Further, a heat sink 56 54 may be disposed proximate the light source 32 and/or the PCB 52. In the illustrated embodiment, a first light source 32 is disposed at a first end of a light guide 50 to emit light at a first wavelength through the light guide 50. A second light source 68b is disposed at the opposing end of the light guide 50. The second light source 68b may emit light at the first wavelength or at a second wavelength. In alternative embodiments, the elongated light assembly 26 may include a photoluminescent structure containing two photoluminescent materials wherein the first photoluminescent material is excitable by light at the first wavelength and the second luminescent material is excitable by light at the second wavelength. It is contemplated that any number of light sources and differing photoluminescent structures may be disposed within the elongated light assembly 26 to create a multitude of lighting effects in differing colors. Alternatively, the photoluminescent structure may be applied on the outer surface of the light source 32 and/or light guide 50.

Light source 32 may be configured to emit non-focused light that excites a substantial portion of the photoluminescent structure 10. Light source 32 may be configured as various light types, such as, but not limited to, halogen lights, fluorescent lights, light emitting diodes (LEDs), organic LEDs (OLEDs), and polymer LEDs (PLEDs). In one embodiment, an LED 68a may be placed at either end of the light guide 50. The respective LEDs 68a, 68b may be disposed proximate to the light guide 50 and are not limited to any particular number. However, by positioning the light sources, which may be disposed on the PCBs 52, at either end of the light guide 50, fewer LEDs 68a, 68b may be required to evenly illuminate the photoluminescent structure, thereby reducing build cost. For example, with respect to the elongated light assembly 26 shown in FIG. 2, it may be possible to sufficiently illuminate the area behind the housing 46 by only providing LEDs 68a, 68b in the middle and/or at an end of the light guide 50. Alternatively, LEDs 68b may be placed in series or in parallel along the housing 46 in a position that faces the photoluminescent structure.

It is also contemplated that any number of light sources may be placed at any position within the elongated light assembly 26. Thus, instead of light guide 50, a light source 32 may be disposed within a member of any practicable shape anywhere within the assembly, or alternatively, the light source 32 may be mounted directly onto the substrate 38 such that illumination of the light source 32 may excite the photoluminescent structure disposed within the assembly.

In operation, portions of the housing 46 that are covered by the photoluminescent structure may be configured to luminesce in response to excitation by light emitted from light source 32. Specifically, the photoluminescent structure may be configured to perform an energy conversion on light emitted from light source 32. In one embodiment, the photoluminescent structure is configured to down convert light received from light source 32 to a new light of a longer wavelength. Light source 32 may be an LED 68a configured to emit ultraviolet light (˜10-400 nanometers in wavelength), violet light (˜380-450 nanometers in wavelength), or blue light (˜450-495 nanometers in wavelength) to take advantage of the relative low cost that is attributed with those types of LEDs. The converted light emitted from the photoluminescent structure may correspond to a visible light, which includes the portion of the electromagnetic spectrum that can be detected by the human eye (˜390-700 nanometers in wavelength) and may be expressed in a variety of colors defined by a single wavelength (e.g., red, green, blue) or a mixture of multiple wavelengths (e.g., white). Thus, it should be understood that the photoluminescent structure may be configured such that converted light emitted therefrom is expressed as unicolored or multicolored light. For instance, the photoluminescent structure may be configured to convert light emitted from light source 32 into white light, which may provide a cost effective alternative to using white LEDs.

According to one embodiment, the photoluminescent structure is substantially Lambertian, that is, the apparent brightness of the photoluminescent structure is substantially constant regardless of an observer's angle of view. As a consequence, converted light may be emitted outwardly from the photoluminescent structure in numerous directions. With respect to the embodiment shown in FIG. 3, a portion of the converted light may be transmitted through the light guide 50 and outputted from the portions of the housing 46 via the front, top, and bottom 60, 62, and 64 portions of the housing 46, thereby causing those portions to exhibit luminescence.

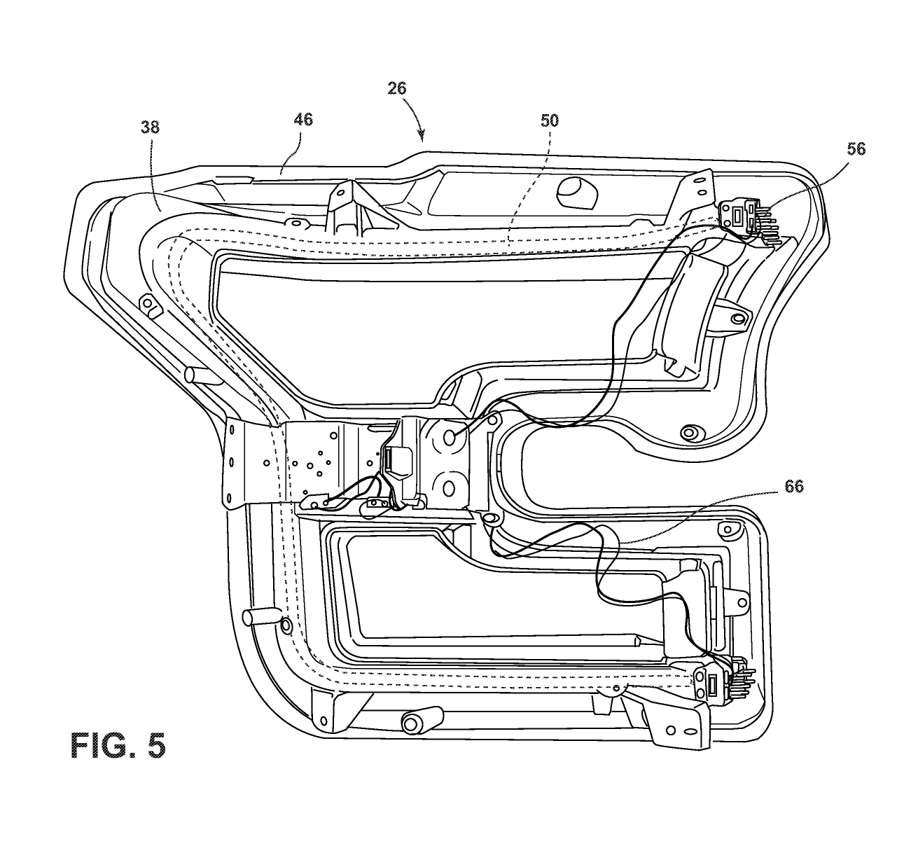

Referring to FIG. 5, the elongated light assembly 26 includes a substrate 38 with a light guide 50 disposed therein and a housing 46 coupled to the substrate 38 thereby substantially encasing the light guide 50. The light guide 50 emits light provided by a light source 32 within the assembly. Appropriate wiring 66 is also included to power the light source 32 of the headlight assembly 24 and respective elongated light assembly 26, as discussed herein. A heat sink 56 is disposed within the assembly to dissipate heat from the headlight assembly 24. The housing 46 may be of any practicable material. The housing 46 has a photoluminescent material disposed therein and/or thereon. Thus, a luminescent portion 34 on the housing 46 is excited when the light guide 50 illuminates the area between the housing 46 and the substrate 38. The luminescent portion 34 converts light from the first wavelength to a second wavelength, as described herein.

The elongated light assembly 26 may be manufactured through a three shot injection molding process. A wide variety of multi-material injection molding processes may be used for making the multi-material elongated light assembly 26. Likewise, different portions may be made of different materials. Due to fabrication and assembly steps being performed inside the molds, molded multi-material objects allow significant reduction in assembly operations and production cycle times. Furthermore, the product quality can be improved, and the possibility of manufacturing defects, and total manufacturing costs can be reduced. In multi-material injection molding, multiple different materials are injected into a multi-stage mold. The sections of the mold that are not to be filled during a molding stage are temporally blocked. After the first injected material sets, then one or more blocked portions of the mold are opened and the next material is injected. This process continues until the required multi-material part is created.

According to one embodiment of the present invention, a multi-shot molding process is used to create the elongated light assembly 26. Additional optics may also be molded into the substrate 38 during the multi-material injection molding process. Initially, the substrate 38 is formed through a first injection molding step. A light guide 50 is then molded and coupled to the substrate 38 in a second injection molding step. Lastly, a light source 32, PCB 52, and/or heat sink 56 is placed into the mold and thereby attached to substrate 38 and elongated light assembly 26 through injection molding of any other known attachment method, such as vibration welding. In alternative embodiments, additional components may be added during one of the three injection steps, or successively added in additional injections thereby adhering more components to the elongated light assembly 26. A luminescent material is then applied to the assembly as discussed above. In some embodiments, the entire assembly may have a luminescent material applied to it. In alternate embodiments, only portions of the assembly have luminescent structures disposed thereon. Additional coloring may be applied to any component of the elongated light assembly 26 to achieve a desired color or to make a surface have a specific property, such as a desired level of reflectivity.

In yet another embodiment, first and second photoluminescent structures may be disposed on or within the elongated light assembly 26. The first photoluminescent structure may be excited by light at a first wavelength. The second photoluminescent structure may be excited by light at a second wavelength. The light may be supplied by a single light source 32 or by first and second light sources 68b.

Still referring to FIG. 5, the substrate 38 or housing 46 may have additional materials disposed thereon. For example, a chrome material may be coupled to the housing 46. The material may be coupled through any known process, such as, but not limited to, electroplating, as described above. Any material applied to any exterior surface of the headlight assembly 24 may be partially translucent so that light from the photoluminescent structure may emit through the material. In some embodiments, it may also be preferred to allow light from the elongated light assembly 26, in addition to the light from the photoluminescent structure to emit through any exterior material disposed on the headlight assembly 24 to create additional lighting effects.

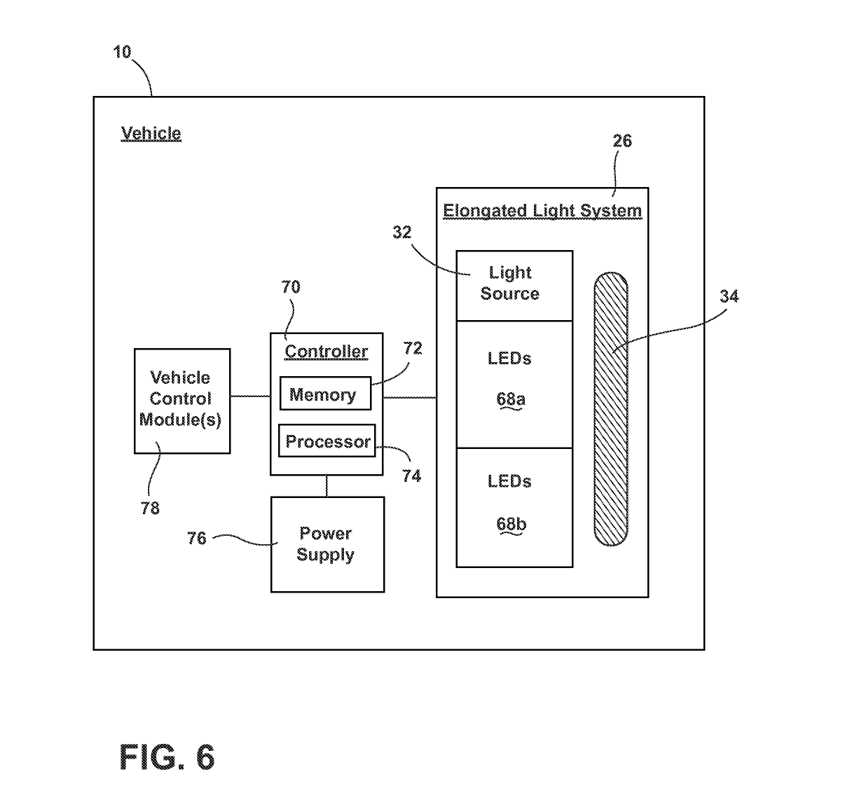

Referring to FIG. 6, a box diagram of a vehicle is shown in which an elongated lighting system is implemented. The lighting system includes a controller 70 in communication with the light source 32. The controller 70 may include memory 72 having instructions contained therein that are executed by a processor 74 of the controller. The controller 70 may provide electrical power to the light source 32 via a power supply 76 located onboard the vehicle 22. In addition, the controller 70 may be configured to control the light output of each light source 32 based on feedback received from one or more vehicle control modules such as, but not limited to, a body control module 78, engine control module, steering control module, brake control module, the like, or a combination thereof. By controlling the light output of the light source 32 the photoluminescent structure may illuminate in a variety of colors and/or patterns to provide ambient light or useful vehicle information to an intended observer. For example, the illumination provided by the photoluminescent structure may be used for numerous vehicle applications, such as, but not limited to, a car finding feature, a remote start indicator, a door lock indicator, a door ajar indicator, a warning indicator, a turn indicator, a brake indicator, etc.

In operation, the photoluminescent structure may exhibit a constant unicolor or multicolor illumination. For example, the controller 70 may prompt the light source 32 to emit only the first wavelength of light via LEDs 68b to cause the photoluminescent structure to illuminate in the first color (e.g., white). Alternatively, the controller 70 may control the light source 32 to emit only the second wavelength of light via LEDs 68b to cause the photoluminescent structure to illuminate in the second color (e.g., amber). Alternatively still, the controller 70 may control the light source 32 to simultaneously emit the first and second wavelengths of light to cause the photoluminescent structure to illuminate in a third color (e.g., yellow) defined by an additive light mixture of the first and second colors. Moreover, additional photoluminescent structures may be added to the lighting system that converts the first and/or second emissions from the light source 32 to a third and/or fourth emission. The third and fourth emissions may be of any wavelength and may combine to form a substantially white light proximate the rear portion of a vehicle 22.

In another embodiment, the photoluminescent structure may exhibit periodic unicolor or multicolor illumination. For example, the controller 70 may control the light source 32 to periodically emit only the first wavelength of light via LEDs 68b to cause the photoluminescent structure to periodically illuminate in the first color. Alternatively, the controller 70 may control the light source 32 to periodically emit only the second wavelength of light via LEDs 68b to cause the photoluminescent structure to periodically illuminate in the second color. Alternatively, the controller 70 may control the light source 32 to simultaneously and periodically emit the first and second wavelengths of light to cause the photoluminescent structure to periodically illuminate in a third color defined by an additive light mixture of the first and second colors. Alternatively still, the controller 70 may control the light source 32 to alternate between periodically emitting the first and second wavelengths of light to cause the photoluminescent structure to periodically illuminate by alternating between the first and second colors. The controller 70 may control the light source 32 to periodically emit the first and/or second wavelengths of light at a regular time interval and/or an irregular time interval.

With respect to the above examples, the controller 70 may modify the intensity of the emitted first and second wavelengths of light by pulse-width modulation or current control. In some embodiments, the controller 70 may be configured to adjust a color of the emitted light by sending control signals to adjust an intensity or energy output level of the light source 32. For example, if the light source 32 is configured to output the first emission at a low level, substantially all of the first emission may be converted to the second emission. In this configuration, a color of light corresponding to the second emission may correspond to the color of the emitted light from the elongated light system component. If the light source 32 is configured to output the first emission at a high level, only a portion of the first emission may be converted to the second emission. In this configuration, a color of light corresponding to mixture of the first emission and the second emission may be output as the emitted light emitted light. In this way, each of the controllers may control an output color of the emitted light.

Though a low level and a high level of intensity are discussed in reference to the first emission it shall be understood that the intensity of the first emission may be varied among a variety of intensity levels to adjust a hue of the color corresponding to the emitted light from the elongated light system component. As described herein, the color of the second emission may be significantly dependent on the particular photoluminescent materials utilized in the photoluminescent structure 10. Additionally, a conversion capacity of the photoluminescent structure 10 may be significantly dependent on a concentration of the photoluminescent materials utilized in the photoluminescent structure 10. By adjusting the range of intensities that may be output from the light source 32 the concentration and proportions of the photoluminescent structures 10 in the luminescent portion 34 and the types of photoluminescent materials utilized in the luminescent portion 34 the lighting devices discussed herein may be operable to generate a range of color hues of the emitted light by blending the first emission with the second emission.

Accordingly, a lighting system for a headlight assembly 24 employing a luminescent elongated light assembly 26 therein that employs one or more photoluminescent structures configured to convert light received from an associated light source 32 and re-emit the light at a different wavelength has been advantageously described herein. The lighting system may provide various benefits including a simple and cost-effective means to produce a variety of illumination that may be used as a styling feature and/or to inform an intended user of a particular vehicle status.

It is also important to note that the construction and arrangement of the elements of the disclosure as shown in the exemplary embodiments are illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown in multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system might be constructed from any of the wide variety of materials that provide sufficient strength or durability, in any of the wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An elongated light assembly for a vehicle, comprising:
a substrate mated to a housing; and
a light source disposed between the substrate and housing, wherein a portion of the housing is configured to luminesce in response to excitation by light emitted from the light source.

2. The light assembly of claim 1, further comprising a printed circuit board disposed inside the housing, wherein the light source is disposed on the printed circuit board.

3. The light assembly of claim 1, further comprising a light guide disposed within the substrate and configured to guide light at a first wavelength through a portion of the housing.

4. The light assembly of claim 1, wherein the light source comprises a plurality of LEDs configured to excite a photoluminescent structure on the housing.

5. The light assembly of claim 1, wherein the luminescent portion of the housing includes first and second photoluminescent structures, the first photoluminescent structure configured to luminesce in a first color at a first wavelength and the second photoluminescent structure configured to luminesce in a second color that is visually distinct from the first color.

6. The light assembly of claim 1, wherein a portion of the housing is metalized to have an outward metallic appearance.

7. The light assembly of claim 1, wherein the light source is disposed at an end of a light guide, the light guide configured to emit light along the body thereof.

8. An elongated light assembly comprising:
an elongated substrate;
an elongated light guide disposed within the substrate;
a light source disposed at a first end of the substrate, wherein the light source emits light at a first wavelength through the light guide;
a housing coupled to the substrate; and
a first photoluminescent material disposed on the housing, the first photoluminescent material configured to convert the light at the first wavelength to a second wavelength.

9. The elongated light assembly of claim 8, further comprising:
a second photoluminescent portion disposed proximate the first photoluminescent portion.

10. The elongated light assembly of claim 8, wherein the second photoluminescent portion is configured to convert the first wavelength to a third wavelength.

11. The elongated light assembly of claim 8, further comprising;
a heat sink within the assembly.

12. A method for forming an elongated light assembly comprising:
injection molding a substrate;
injecting and coupling a light guide to the substrate within a mold;
placing a printed circuit board and light source into the mold; and
molding the printed control board and light source to the substrate and light guide.

13. The method of claim 12, further comprising:
injecting and coupling a housing to the substrate.

14. The method of claim 12, further comprising:
applying a first photoluminescent material to a portion of the assembly, wherein the photoluminescent material converts light from the light source at a first wavelength to a second wavelength.

15. The method of claim 12, wherein the light source is disposed at an end of the light guide.

16. The method of claim 15, further comprising:
attaching a second light source to the elongated light assembly disposed at a second end of the light guide, the second light source emitting light at a different wavelength than the first light source.

17. The method of claim 16, further comprising:
applying a second photoluminescent material to a portion of the assembly, wherein the photoluminescent material converts light from the light source at a first wavelength to a second wavelength.

18. The method of claim 12, further comprising:
applying a partially reflective coating to a portion of the light bar that is visible when the part is installed on a vehicle.

19. The method of claim 12, further comprising:
metalizing a portion of the housing to have an outward metallic appearance.

20. The method of claim 12, wherein injection molding a substrate includes molding printed optics onto the substrate.
